(19) United States
(12) Patent Application Publication
(10) Pub. No.: US 2016/0110030 A1
(43) Pub. Date: Apr. 21, 2016

(54) SYSTEM AND METHOD FOR FILTERING PHOTOS, TEXT, AND VIDEOS BY USERS CHOICE

(71) Applicant: Mitchel Andre Bohi, Burglen (CH)

(72) Inventor: Mitchel Andre Bohi, Burglen (CH)

(21) Appl. No.: 14/515,143

(22) Filed: Oct. 15, 2014

(51) Int. Cl. G06F 3/0482; G06F 3/0484; H04L 29/06

(52) U.S. Cl. CPC G06F 3/0482; H04L 65/403; G06F 3/04842; G06F 3/04847

(57) ABSTRACT

A system, computer program, and method for aggregating and filtering different types of content from multiple social media networks. The executed computer program may display a first set of user selectable items and a second set of user selectable items on a display screen of a hand-held communication device. Items in the first set may each correspond to one of the social media networks and items in the second set may each correspond to a type of content from the social media networks. The hand-held communication device may receive a selection from a user of any combination of the user selectable items of the first set and the second set for aggregation and filtering purposes. Then the hand-held communication device may display content from the social media networks, filtered according to the received selections.

### BACKGROUND

Social media networks, such as FACEBOOK, TWITTER, and INSTAGRAM, allow individuals to communicate with each other remotely and post content of interest to be viewed by other individuals of their choosing. This content may include photos, videos, text, and other types of content. However, a user must open multiple different software programs or smartphone apps to view separate content streams for each of the social networks to which the user is subscribed. This can be time consuming and waste battery life of the phone, tablet, or other device being used to view the social network postings. While some programs aggregate entire content streams of several different social media networks, these programs are difficult to use and do not provide an easy interface for user customization and filtering of types of content displayed.

### SUMMARY OF THE INVENTION

Embodiments of the present invention solve the above-mentioned problems and provide a distinct advance in the art of filtering and displaying aggregated social media content. Specifically, embodiments of the present invention may provide systems, methods, and computer programs that aggregate and selectively filter content streams from selected social media networks based on user-selected content types.

One embodiment of the invention provides a computer program for operating functions of a handheld communication device having a display screen. The computer program may include executable code segments displaying a first set of user selectable items each corresponding to one of a plurality of social media networks and a second set of user selectable items each corresponding to one of a plurality of different types of content from the social media networks. The content may include photos, videos, and/or text. The computer program may also include a code segment for receiving a selection of at least one of the user selectable items of the first set and a selection of at least one of the user selectable items of the second set from the user and a code segment for displaying content from the social media networks, filtered according to the received selections. That is, the content displayed on the display screen may only include the types of content selected by the user from the social media networks selected by the user.

Another embodiment of the invention is a handheld communication device for aggregating and filtering different types of content from a plurality of social media networks. The handheld communication device may include a display screen, a user interface, a processing element communicably coupled with the user interface and the display screen, and a memory element communicably coupled with the processing element. The memory element may have a computer program stored thereon for operating functions of the handheld communication device. Specifically, the computer program may include code segments, executable by the processing element, displaying on the display screen a first set of user selectable items each corresponding to one of at least three social media networks and a second set of user selectable items each corresponding to one of at least three different types of content from the social media networks. The content may include photos, videos, and/or text. The user selectable items of the first set and the second set may be presented in a grid on a single user interface screen. The computer program may also include a code segment for receiving a selection from the user interface of at least two of the user selectable items of the first set and a selection of at least two of the user selectable items of the second set, and presenting, on the display screen, content from the plurality of social media networks. The content displayed on the display screen may only include the types of content selected by the user from the social media networks selected by the user and may exclude the types of content not selected by the user or not received from the social media networks selected by the user.

According to another embodiment of the invention, a computer-implemented method for aggregating and filtering different types of content from a plurality of social media networks may include the step of presenting, on a display screen of a hand-held communication device, a first set of user selectable items and a second set of user selectable items. The first set of user selectable items may each correspond to one of a plurality of social media networks, and the second set of user selectable items may each correspond to one of a plurality of different types of content from the social media networks. The method may further include the steps of receiving a selection of at least two of the user selectable items of the first set and a selection of at least two of the user selectable items of the second set from a user of the communication device, and displaying content from the social media networks, filtered according to the received selections. That is, the content displayed on the display screen may only include the types of content selected by the user from the social media networks selected by the user and may exclude the types of content not selected by the user or not received from the social media networks selected by the user.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF THE DRAWING FIGURES

Embodiments of the current invention are described in detail below with reference to the attached drawing figures, wherein:

FIG. 1 is a schematic block diagram of a system for operating a content aggregation and filtering social media computer program, constructed in accordance with various embodiments of the present invention;

FIG. 2 is a schematic block diagram of the components of a server device;

FIG. 3 is a schematic block diagram of the components of a user device;

FIG. 4 is a flow diagram of at least a portion of the steps of a method for operating a content aggregation and filtering social media computer program; and

FIG. 5 is a screen shot of a selection menu of selectable checkboxes associated with available types of content and social media networks, as displayed on one of the user devices of FIG. 1;

FIG. 6 is a screen shot of a selection menu grid of selectable graphic icons associated with available types of content and social media networks, as displayed on one of the user devices of FIG. 1;

FIG. 7 is a screen shot of a selection menu of selectable buttons featuring graphic icons associated with available types of content and social media networks, as displayed on one of the user devices of FIG. 1;

FIG. 8 is a screen shot of a selection menu of selectable graphic icons associated with available types of content and social media networks and of a “go” button for applying the aggregation and filtering, as displayed on one of the user devices of FIG. 1;

FIG. 9 is a screen shot of a selection menu of selectable text and graphic icons associated with available types of content and social media networks, as displayed on one of the user devices of FIG. 1;

FIG. 10 is a screen shot of a selection menu of graphical sliders associated with available types of content and social media networks, as displayed on one of the user devices of FIG. 1; and

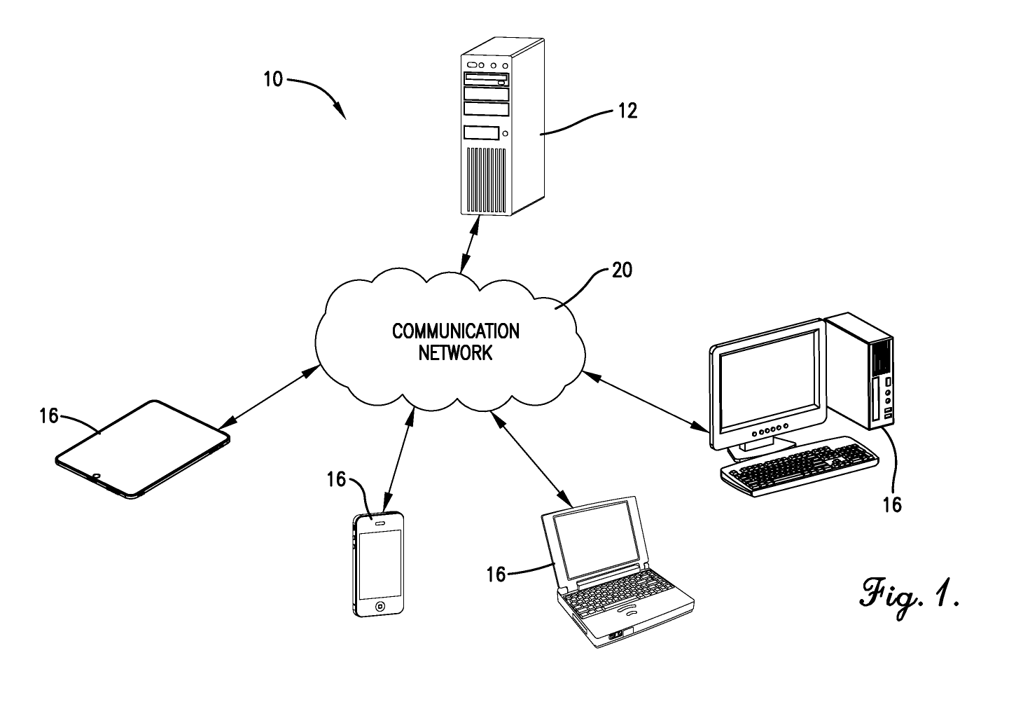

FIG. ills a screen shot of a content stream of aggregated and filtered content, as displayed on one of the user devices of FIG. 1.

The drawing figures do not limit the current invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the current invention. The following detailed description is, therefore, not to be taken in a limiting sense. The scope of the current invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

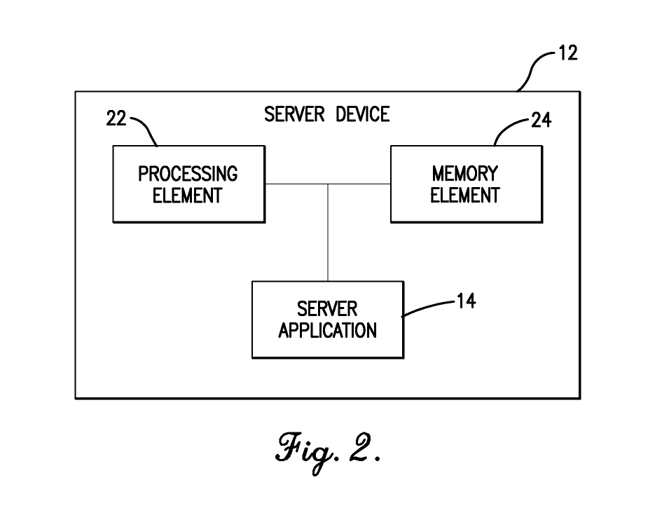

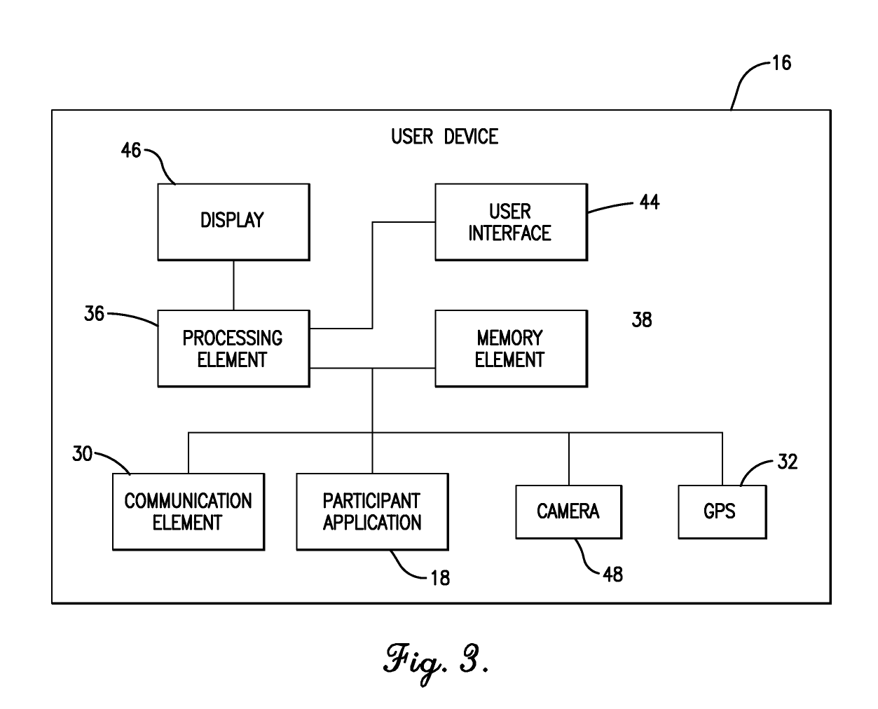

A system 10 that may be used to implement aspects of the present invention is shown in FIG. 1. Embodiments of the invention are configured to filter social media content by user selection of a plurality of social media networks and a plurality of types of content. The system 10 may broadly comprise one or more server devices 12 having one or more server applications 14, as illustrated in FIG. 2, for storing and managing the social media networks. Furthermore, the system 10 may comprise and/or communicate with a plurality of user devices 16, as illustrated in FIG. 1, each executing an associated user application 18, as illustrated in FIG. 3, for aggregating and filtering content from various social media networks. Communication with the user devices 16 may occur through a communication network 20. Various embodiments of the current invention may be implemented in hardware, software, firmware, or combinations thereof.

As illustrated in FIG. 2, the server device 12 generally stores electronic data and may include application servers, database servers, file servers, mail servers, print servers, web servers, or the like, or combinations thereof. The server device 12 may be implemented in a dedicated network or an open network like the World Wide Web or a cloud network. Furthermore, the server device 12 may include a plurality of physical servers, virtual servers, or combinations thereof. In some embodiments, the server device 12 may be physically separated or isolated from the user devices 16. In other embodiments, the server device 12 may be included with, retained by, or executed on one or more of the user devices 16. The server device 12 may be configured to include or execute software such as database applications, web server applications, file server applications, mail server applications, or the like.

The server devices 12 may include at least one processing element 22 and at least one memory element 24, as shown in FIG. 2. The processing element 22 may include microprocessors, microcontrollers, digital signal processors (DSPs), field-programmable gate arrays (FPGAs), analog and/or digital application-specific integrated circuits (ASICs), and the like, or combinations thereof. The processing element 22 may generally execute, process, or run instructions, code, software, firmware, programs, applications, apps, services, daemons, or the like, or may step through states of a finite-state machine.

The memory element 24 may include data storage components such as read-only memory (ROM), programmable ROM, erasable programmable ROM, random-access memory (RAM), hard disks, floppy disks, optical disks, flash memory, thumb drives, universal serial bus (USB) drives, and the like, or combinations thereof. The memory element 24 may include, or may constitute, a “computer-readable medium”. The memory element 24 may store instructions, code, software, firmware, programs, applications, apps, services, daemons, or the like that are executed by the processing element 22. The memory element 24 may also store settings, data, user profiles, documents, sound files, photographs, images, videos, movies, text, web links, databases, and other types of social media-related content. The term photograph, as used herein, may include any digital still image displayable on a graphical display screen. The processing element 22 may be in communication with the memory element 24 through address busses, data busses, control lines, and the like.

The server application 14 generally maintains the data related to the various social networks described herein. The server application 14 may be formed from instructions, code, software, firmware, programs, applications, apps, processes, services, daemons, or the like. In various embodiments, at least a portion of the server application 14 may be implemented as a web site or web application which provides access to or viewing of user profiles and user-posted content. In other embodiments of the invention, at least a portion of the server application 14 may be implemented as a mobile app on a smart phone, tablet, or other mobile computing device. Furthermore, the server application 14 may include data communications applications such as social networking, electronic mail, messaging such as the short message service (SMS), and the like.

The user devices 16 generally allow users to manage various social media accounts, profiles, and types of content viewed via the server application 14 and the user application 18 described below. Specifically, the user devices 16 may allow the users to communicate with the server device 12, sending and receiving content associated with various social media networks. The user devices 16 may include electronic devices capable of executing an application and communicating through the communication network 20. Examples of the user device 16, as shown in FIG. 1, include handheld communication devices, smartphones, mobile phones, cellular phones, personal digital assistants (PDAs), tablets or tablet computers, and the like. Additionally or alternatively, the user device 16 may include workstation computers, desktop computers, laptop computers, palmtop computers, notebook computers, and the like. The user devices 16 may also include file servers, application servers, database servers, and the like.

In some embodiments of the invention, each user device 16 includes a processing element 36, a memory element 38, and a communication element 30, as seen in FIG. 3. The processing element 36 may be substantially the same as the processing element 22 in structure and/or function. Specifically, the processing element may be programmed, utilizing programs in the memory element to perform selected functions. Specifically, the processing element of the current invention is programmed to aggregate and filter a plurality of types of content from a plurality of social media networks and display the selected types of content on a single user interface screen. The memory element 38 may be substantially the same as the memory element 24 in structure and/or function. Specifically, the memory element may store programs, applications, or instructions for the processing element to execute.

The communication element 30 may allow communication between the user device 16 and external systems or devices, such as the server device 12, the communication network 20, or other user devices 16. The communication element 30 may communicate wirelessly and/or through wires. Wireless communication may utilize radio frequency (RF) communication including cellular or mobile phone standards such as 3G or 4G, Institute of Electrical and Electronics Engineers (IEEE) 802.11 standards for wireless networking, Bluetooth™ standards, and the like. Accordingly, the user device 16 may include one or more broadband wireless transmitters and receivers. Wired communications may be implemented through metal conductor cables, wires, and connectors or optical fiber cables. Thus, each user device 16 may include one or more transmitter and receiver circuits for use with cables.

The user devices 16 may further include or be in communication with a geolocation device 32 that determines the geographical position of the device. The geolocation device may be or include a satellite navigation receiver that works with a global navigation satellite system (GNSS) such as the global positioning system (GPS) primarily used in the United States, the GLONASS system primarily used in the Soviet Union, or the Galileo system primarily used in Europe. The geolocation device may include an antenna to assist in receiving the satellite signals. The antenna may be a patch antenna, a linear antenna, or any other type of antenna that can be used with location or navigation devices. The geolocation device may further include one or more processors, controllers, or other computing elements and memory so that it may calculate location and other geographic information. However, the geolocation device 32 may be omitted without departing from the scope of the invention.

In some embodiments of the invention, as illustrated in FIG. 3, the user devices 16 may also include cameras 48 configured for capturing digital photos, video, and the like. Likewise, the user devices 16 may have microphones configured for receiving audio, which may be saved and/or processed for inclusion with videos recorded by the cameras 48. However, some or all of the user devices 16 may omit the camera 48 and/or the microphone without departing from the scope of the invention.

The user devices 16 may also each include a display screen 46 to display information and graphics to a user thereof. In some embodiments of the invention, the display screen 46 may comprise an LCD (Liquid Crystal Diode) display, a TFT (Thin Film Transistor) LCD display, an LEP (Light Emitting Polymer) or PLED (Polymer Light Emitting Diode) display, and so forth, configured to display text and/or graphical information such as a graphical user interface. The display screen 46 may be backlit via a backlight such that it may be viewed in the dark or other low-light environments. In some embodiments of the invention, the display screen 46 may not be integrated into the user device 16 and may instead be connected externally using universal serial bus (USB), Ethernet, serial connections, and so forth. In some embodiments of the invention, the display screen 46 may be provided with a touch screen to receive input (e.g., data, commands, etc.) from a user. For example, a user may operate the user device 16 by touching the touch screen and/or by performing gestures on the screen. In some embodiments, the touch screen may be a capacitive touch screen, a resistive touch screen, an infrared touch screen, combinations thereof, and the like.

The user devices 16 may also each additionally include a user interface 44 communicably coupled with the processing element 36. The user interface 44 may be configured for operation by the user to make user selections for which types of content from which social media networks should be displayed via the applications 14,18, as later described herein. The user interface 44 may comprise one or more functionable inputs such as buttons, switches, scroll wheels, keyboards, touch screen associated with the display screen 46, voice recognition elements such as a microphone, pointing devices such as mice, touchpads, tracking balls, styluses, a camera such as a digital or film still or video camera, combinations thereof, etc. The user interface 44 may also include an optional speaker for providing audible instructions and feedback.

The user application 18 generally allows the user to select filter settings and view a content stream, newsfeed, or display window including only the selected types of content for the selected ones of the social media networks. The user application 18 may include software, programs, applications, or apps operable to manipulate relational data, hierarchical data, linked data, tabular data, text data, videos, still images, and the like. The user application 18 may further include applications or programs that are operable to handle data communications such as social networking, electronic mail, messaging such as the short message service (SMS), and the like, as well as web browsers, web viewers, or Internet browsers that are operable to access web sites. For example, at least a portion of the user application 18 may be implemented as mobile apps on a smart phone, tablet, or other mobile computing device which provides access to or viewing of selected types of content from various social media networks. In some embodiments of the invention, the user application 18 may also be able to process and/or post various types of content to corresponding social media networks.

Both the server device 12 and the user devices 16 may comprise one or more computer programs stored in or on computer-readable medium residing on or accessible by the server device 12 and/or the user devices 16. For example, the server application 14 and/or the user application 18 may comprise computer programs. The computer programs may comprise listings of executable instructions for implementing logical functions in the server device 12 and/or the user devices 16 and can be embodied in any non-transitory computer-readable medium, such as the memory elements 24,38, for use by or in connection with an instruction execution system, apparatus, or device, such as a computer-based system, processor-containing system, or other system that can fetch the instructions from the instruction execution system, apparatus, or device, and execute the instructions. In the context of this application, a “computer-readable medium” can be any non-transitory means that can contain, store, or communicate the programs. The computer-readable medium can be, for example, but not limited to, an electronic, magnetic, optical, electro-magnetic, infrared, or semi-conductor system, apparatus, or device. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM).

The communication network 20, as illustrated in FIG. 1, generally allows communication between the user devices 16 and the server device 12 as well as communication from one user device 16 to another. The communication network 20 may include local area networks, metro area networks, wide area networks, cloud networks, the Internet, or the like, or combinations thereof. The communication network 20 may also include or connect to voice and data communication systems such as cellular networks and public ordinary telephone systems. The communication network 20 may be wired, wireless, or combinations thereof and may include components such as switches, routers, hubs, access points, and the like. The user devices 16 may connect to the communication network 20 either through wires, such as electrical cables or fiber optic cables, or wirelessly through known RF standards as discussed above.

In use, the user devices 16 provide a visual display of selectable aggregation and filtering options for displaying only specific types of content from specific social networks. The types of content may include photographs, video, text, web links, and/or other types of electronic data, such as .gif files or the like. The social media networks may include various social media websites or associated databases, social media apps configured for smartphones or tablets, or other social media channels known in the art. For example, social media networks may include FACEBOOK, TWITTER, INSTAGRAM, GOOGLE+, PINTREST, VINE, SECRET, and the like. In general, social media networks may allow a plurality of users to post and view each other's posted digital media, such as digital images, photographs, video, text, and web links. Posted digital media may be viewed in a newsfeed, content stream, or other types of data feeds or streams and may be aggregated for viewing by various ones of the users based on privacy settings of the posts and preferences set by the various ones of the users.

The user device 16 may receive content from the server device 12 associated with various ones of the social media networks. The user application 18 may be executed by the user device 16 to provide user-selectable aggregation and filter options. These options may include which social media networks and which types of content to display on the display screen 46, as described in detail below.

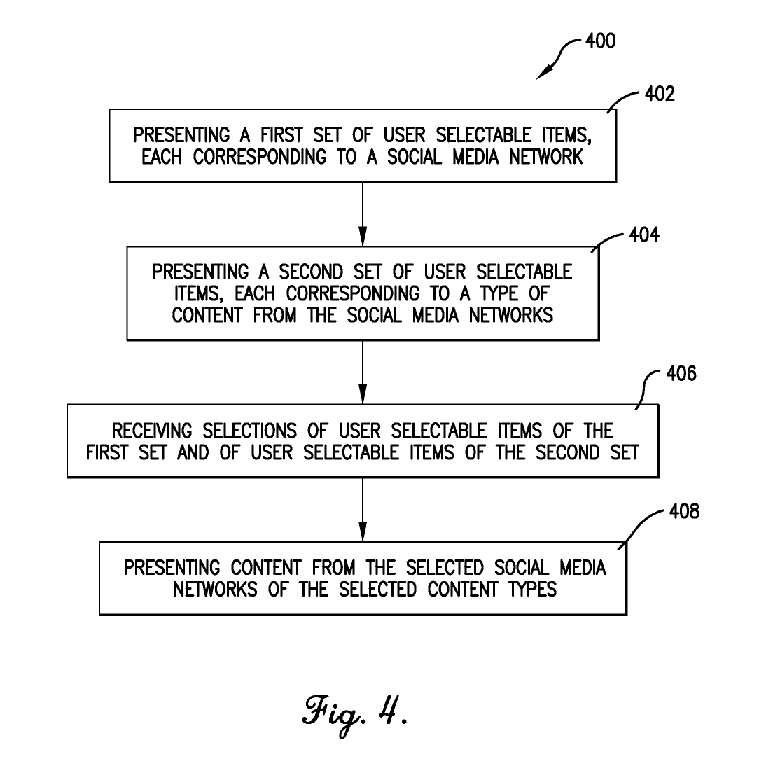

FIG. 4 illustrates steps in a method 400 for aggregating and filtering of content from a plurality of social media networks and/or portions of code of computer programs, in accordance with various embodiments of the present invention. The steps of the method 400 and/or portions of the computer programs, may be performed in the order as shown in FIG. 4, or they may be performed in a different order. Furthermore, some steps may be performed concurrently as opposed to sequentially. In addition, some steps may not be performed. Some of the steps may represent code segments or executable instructions of the computer program or applications described above.

The method 400 may comprise the steps of presenting on the display screen 46 a first set of user selectable items each corresponding to one of the social media networks, as depicted in block 402, and presenting on the display screen 46 a second set of user selectable items each corresponding to one of the different types of content from the social media networks, as depicted in block 404. The different types of content includes photos, videos, text, and the like, as described above. Preferably, two or more social media networks and/or two or more types of content may be displayed in a single, user-friendly display window on the display screen 46. However, in some embodiments of the invention, three or more social media networks and/or three or more types of content may be displayed simultaneously on the single, user-friendly display window on the display screen 46.

Next, the method 400 may include a step of receiving a selection of one or more of the user selectable items of the first set and a selection of one or more of the user selectable items of the second set from a user of the user device 16, as depicted in block 406. For example, in some embodiments of the invention, the selections must include two or more of the first set and/or two or more of the second set of user selectable items. Note that in some embodiments of the invention, the first and second sets of user selectable items may be presented on the display screen 46 in a single user interface screen, such as a single browser window, software window, or the like. This simplifies the selection process and allows the user to make selections without switching between multiple different user interface screens or windows (i.e., opening, closing, minimizing, maximizing, and the like).

In one embodiment of the invention, as illustrated in FIG. 5, selectable boxes or checkboxes 50 may be displayed next to different types of content, such as videos, photos, and text, and selectable boxes or checkboxes 50 may be displayed next to different social media networks, such as FACEBOOK, TWITTER, and INSTAGRAM. In embodiments where the display screen 46 is a touch screen, for example, a user may tap any of the boxes. The user application 18 may then be configured to receive this input and change the displayed graphics to include a checkmark 52 or other indicia in the box checked. Note that the box may be replaced with a circle or other selectable icon without departing from the scope of the invention.

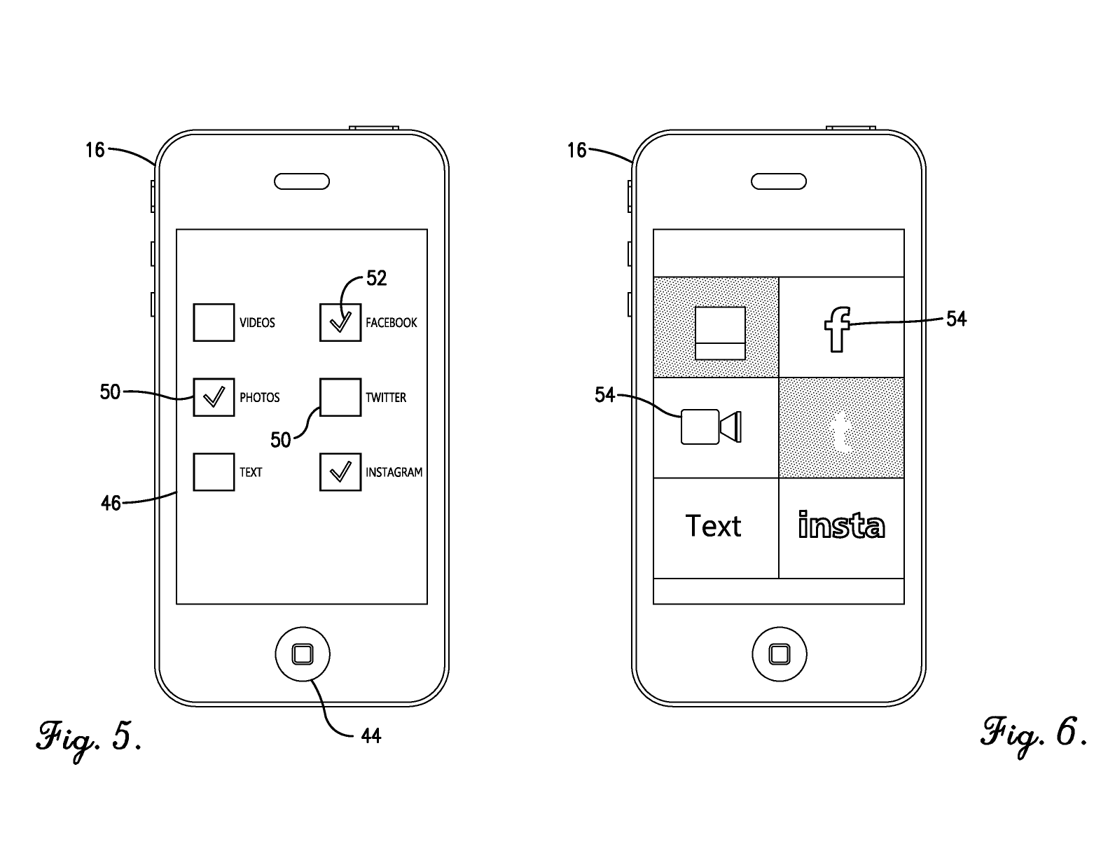

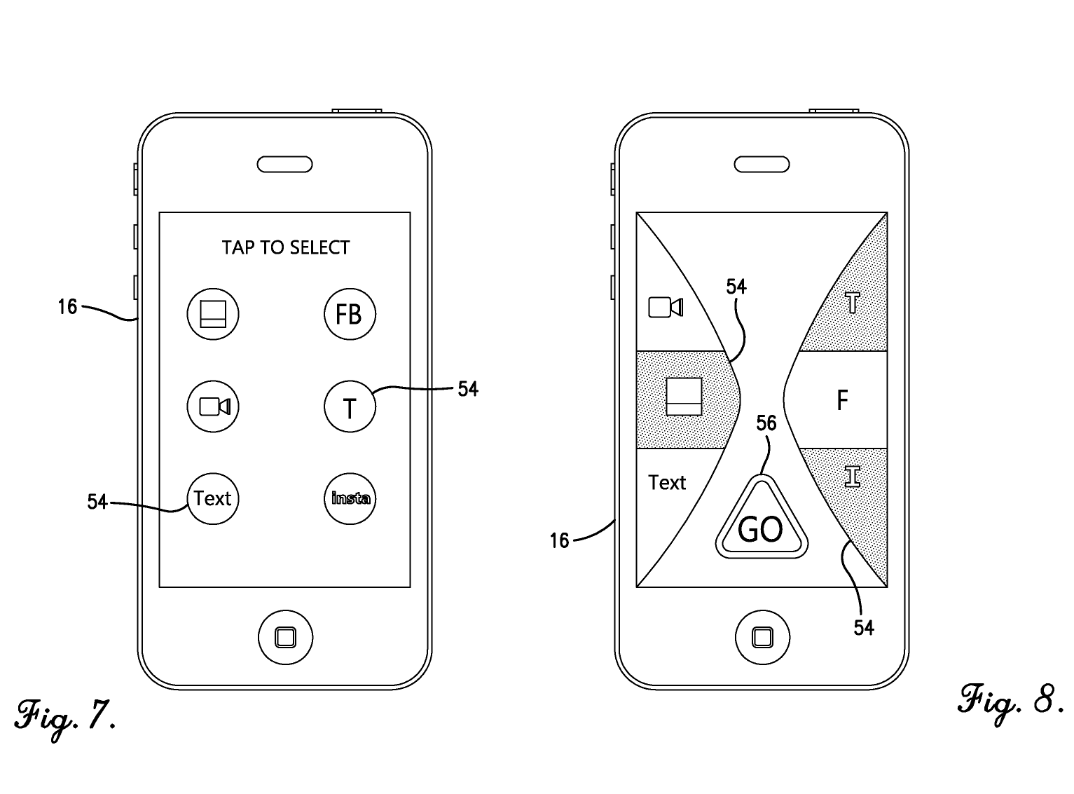

In other embodiments of the invention, as illustrated in FIGS. 6-9, selectable icons 54 representing the different types of content and the different social media networks may be displayed on the display screen 46. For example, as illustrated, the icons 54 representing a photograph, a video, and text may be displayed next to the icons 54 or logos of the various social media networks available. In embodiments where the display screen 46 is a touch screen, once again, the user may tap the icon to indicate a selection, and the user application 18 may then be configured to receive this input and change the display graphics to show the tapped icon as highlighted, shaded, of a different color, or otherwise marked as selected. In some embodiments of the invention, as illustrated in FIG. 8, once the icons 54 are selected by the user, a “go” button 56 or other selectable menu item may be selected by the user to then view the social media network content, aggregated and filtered according to the user's selections.

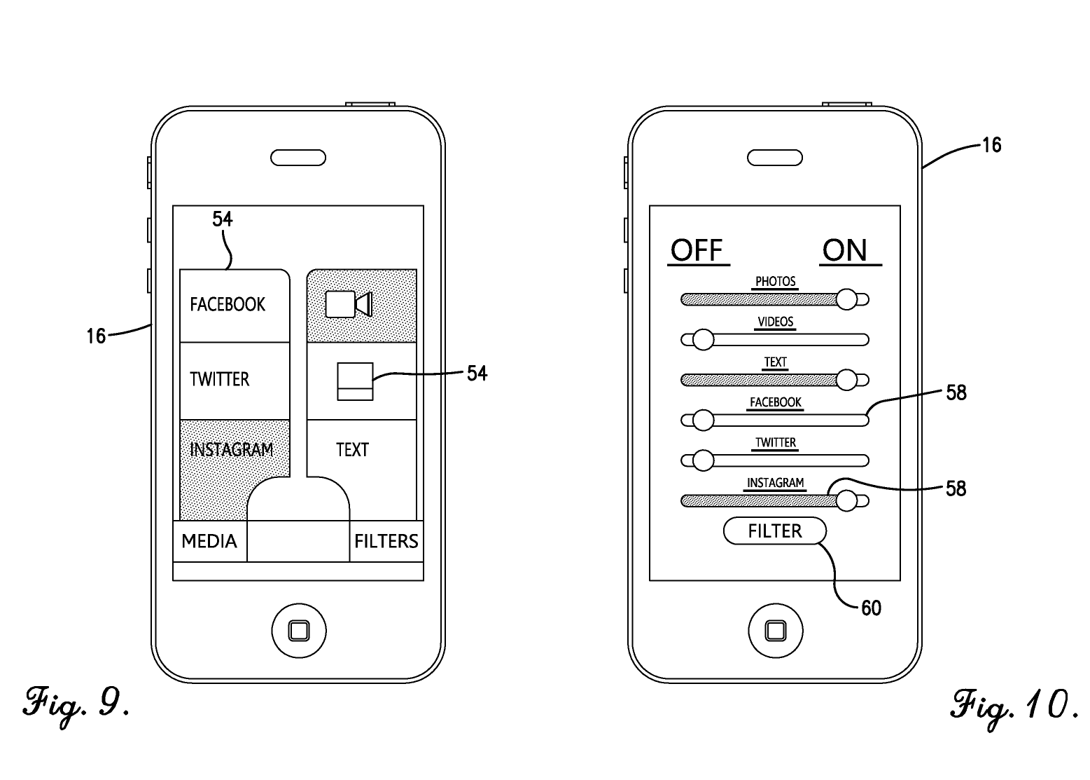

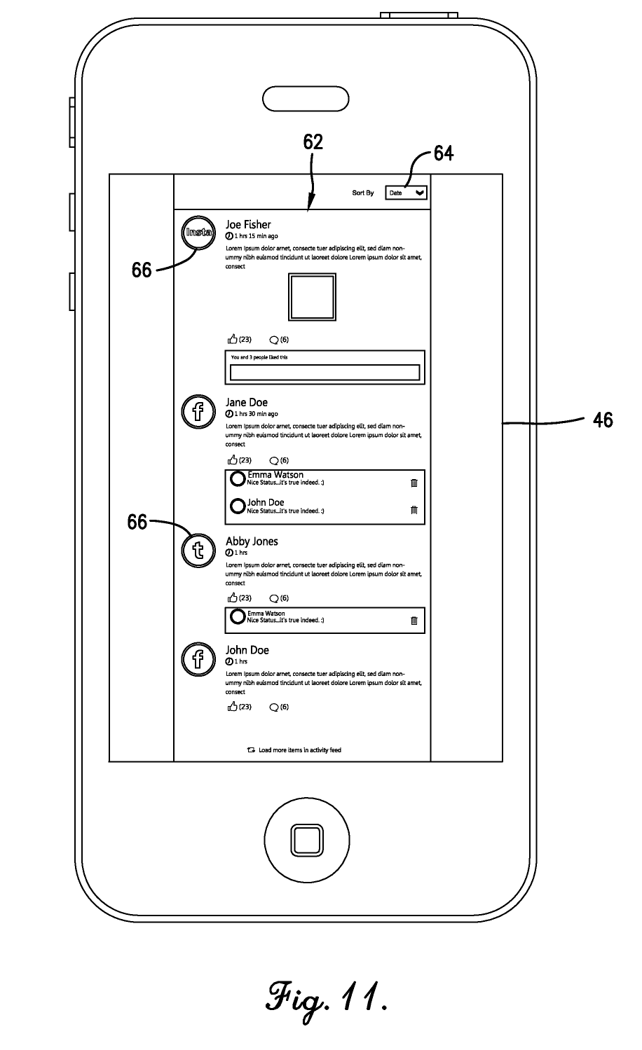

In yet another embodiment of the invention, as illustrated in FIG. 10, selectable sliders 58 may be provided, and may be configured to slide between an on configuration and an off configuration. Each of the sliders 58 may be associated with one of the social media networks and/or one of the types of media content. Once each of the sliders 58 is in the desired off or on configuration or position, the user may select a menu option 60 to apply the aggregation or filtering. For example as illustrated in FIG. 10, a button labeled “filter” may be displayed and may be selectable by the user, such as tapping a location of this menu option 60 on a touch screen.

In some alternative embodiments of the invention, different filters may be applied for each selected social media network. For example, the user could select to only view photos from their FACEBOOK newsfeed, while selecting to view both text and photos appearing on their GOOGLE+ newsfeed and/or page. Any combination of social media networks and types of content may be used without departing from the scope of the invention.

Finally, the method 400 may include a step of presenting on the display screen 46 content from the social media networks according to the received selections, as depicted in block 408. Specifically, the content displayed on the display screen 46 may only include content of the types selected by the user and only from the social media networks selected by the user. For example, if a user selected text only for content type, and selects FACEBOOK and TWITTER icons in step 406, the display in step 408 would only show text statuses from FACEBOOK and TWITTER, omitting any statuses with photos or video.

Specifically, once aggregation and filtering settings are selected by the user, the display screen 46 may display a content stream 62, as illustrated in FIG. 11. Preferably, the content stream 62 may be presented on the display screen 46 in a single user interface screen, such as a single browser window or the like. The content stream 62 may be any known newsfeed, data stream, content stream, or other digital media displaying formats known in the art. The filtered types of content from the selected social media networks may be displayed in any sort of ranking. For example, the content may be ordered according to time and/or date posted, importance of content or post, popularity of content or post, etc. The ranking or placement location may be selected by the user via a drop down menu 64 or other user-selectable graphics displayed on the display screen 46. In some embodiments of the invention, the ranking or placement location of the content displayed may not depend on which social media network the content is associated with. The content may be identified as being associated with a specific one of the selected social media networks using various graphical identifiers 66. For example, a FACEBOOK logo may be displayed next to a status update from another user via FACEBOOK, while an INSTAGRAM logo may be displayed next to a photo originally posted on INSTAGRAM.

In some alternative embodiments of the invention, the user-selectable items, such as the icons 54, may be displayed on a same display window or display screen as the content stream 62, and may be updated substantially in real-time as different aggregation and filter selections are made by the user. Furthermore, in some embodiments of the invention, the user application 18 may allow the user to review daily statistics regarding various content received by various ones of the social media networks, such as number of likes, number of views, and/or number of shares. In some embodiments of the invention, the user application 18 may allow the user to post content to one or more of the social media networks directly from the user application 18. Additionally or alternatively, the user may even simultaneously post content to multiple social media networks via the user application 18. For example, the user may provide picture content (e.g., a post containing a photograph) and then make a selection indicating to post the picture content to both INSTAGRAM and TWITTER.

Embodiments of the current invention provide significantly more than the application of an abstract idea using a generic computer. The current invention provides improvements to the field of social media aggregation, filtering, and display. Prior art approaches failed to provide an easy-to-use interface for aggregating content from multiple social media networks and failed to allow customized filtering of different types of content from multiple social media networks. The current invention is able to not just combine content from different social media networks, but is able to filter the types of content displayed from different social media networks and display these selected types of content from different social media networks on a single user interface screen for the user's convenience. In addition, the user device 16 is necessary to perform the aggregation and filtering of the social media network content. It would require too much time for a human to perform, especially when a large quantity of content is involved. Furthermore, data may be received from social media networks and aggregated and filtered at times when humans are not able or willing to work.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A non-transitory computer readable memory device having a computer program stored thereon for operating functions of a handheld communication device having a display screen, the computer program comprising:
a code segment for presenting on the display screen a first set of user selectable items each corresponding to one of a plurality of social media networks;
a code segment for presenting on the display screen a second set of user selectable items each corresponding to one of a plurality of different types of content from the social media networks;
a code segment for receiving a selection of at least one of the user selectable items of the first set and a selection of at least one of the user selectable items of the second set from a user of the communication device; and
a code segment for presenting, on the display screen, content from the plurality of social media networks, wherein the content displayed on the display screen only includes the types of content selected by the user from the social media networks selected by the user.

2. The computer program of claim 1, wherein the code segments present the user selectable items of the first set and the second set on a single user interface screen.

3. The computer program of claim 1, wherein the plurality of social media networks is selected from the group consisting of social media websites, social media apps, and social media channels.

4. The computer program of claim 1, wherein the plurality of different types of content from the social media networks is selected from the group consisting of photos, videos, and text.

5. The computer program of claim 1, wherein the second set of user selectable items corresponds to at least two different types of content.

6. The computer program of claim 1, wherein the second set of user selectable items corresponds to at least three different types of content.

7. The computer program of claim 1, wherein the first set of user selectable items corresponds to at least two different social media networks.

8. The computer program of claim 1, wherein the first set of user selectable items corresponds to at least three different social media networks.

9. The computer program of claim 1, wherein the content displayed on the display screen, of the types selected and from the social media networks selected by the user, are displayed in order of at least one of: time of posting, date of posting, and popularity, regardless with which of the social media networks the content is associated.

10. A non-transitory computer readable memory device having a computer program stored thereon for operating functions of a handheld communication device having a display screen, the computer program comprising:
a code segment for presenting on the display screen a first set of user selectable items each corresponding to one of three or more social media networks;
a code segment for presenting on the display screen a second set of user selectable items each corresponding to one of three or more different types of content from the social media networks, wherein the plurality of different types of content includes at least two of: photos, videos, and text, wherein the user selectable items of the first set and the second set are presented in a grid on a single user interface screen;
a code segment for receiving a selection of at least two of the user selectable items of the first set and a selection of at least one of the user selectable items of the second set from a user of the communication device; and
a code segment for presenting, on the display screen, content from the plurality of social media networks, wherein the content displayed on the display screen only includes the types of content selected by the user from the social media networks selected by the user.

11. The computer program of claim 10, wherein the code segment for receiving the selection includes receiving at least two of the user selectable items of the second set from the user of the communication device.

12. The computer program of claim 10, wherein the plurality of social media networks is selected from the group consisting of social media websites, social media apps, and social media channels.

13. The computer program of claim 10, wherein the user selectable items of the first set and the second set include at least one of: selectable squares, selectable icons, selectable indicia, slidable on/off indicators, checkboxes, and selectable buttons.

14. The computer program of claim 10, wherein the second set of user selectable items corresponds to at least two different types of content.

15. The computer program of claim 10, wherein the content displayed on the display screen, of the types selected and from the social media networks selected by the user, are displayed in order of at least one of: time of posting, date of posting, and popularity, regardless with which of the social media networks the content is associated.

16. A handheld communication device configured for aggregating and filtering different types of content from a plurality of social media networks, the handheld communication device comprising:
a display screen;
a user interface;
a processing element communicably coupled with the user interface and the display screen; and
a memory element communicably coupled with the processing element, the memory element having a computer program stored thereon for operating functions of the handheld communication device, the computer program comprising:
a code segment, executable by the processing element, for presenting on the display screen a first set of user selectable items each corresponding to one of at least three social media networks;
a code segment, executable by the processing element, for presenting on the display screen a second set of user selectable items each corresponding to one of at least three different types of content from the social media networks, wherein the plurality of different types of content includes at least two of: photos, videos, and text, wherein the user selectable items of the first set and the second set are presented in a grid on a single user interface screen;
a code segment, executable by the processing element, for receiving a selection from the user interface of at least two of the user selectable items of the first set and a selection of at least two of the user selectable items of the second set; and
a code segment, executable by the processing element, for presenting, on the display screen, content from the plurality of social media networks, wherein the content displayed on the display screen only includes the types of content selected by the user from the social media networks selected by the user, wherein the content displayed on the display screen excludes the types of content not selected by the user or not received from the social media networks selected by the user.

17. The handheld communication device of claim 16, wherein the user selectable items of the first set and the second set include at least one of: selectable squares, selectable icons, selectable indicia, slidable on/off indicators, checkboxes, and selectable buttons.

18. The handheld communication device of claim 16, wherein the plurality of social media networks is selected from the group consisting of social media websites, social media apps, and social media channels.

19. The handheld communication device of claim 16, further comprising a communication element configured to communicate with a server device to send and receive photos, videos, and text with the social media networks.

20. The handheld communication device of claim 16, wherein the content displayed on the display screen, of the types selected and from the social media networks selected by the user, are displayed in order of at least one of: time of posting, date of posting, and popularity, regardless with which of the social media networks the content is associated.
